(19) United States
(12) Patent Application Publication
(10) Pub. No.: US 2025/0385702 A1
(43) Pub. Date: Dec. 18, 2025

(54) METHODS AND SYSTEMS FOR PROVIDING INTERNET USING ULTRA HIGH FREQUENCY

(71) Applicant: BUSHTEX, INC., Gilbert, AZ (US)

(72) Inventors: Adelaida Velasco Severson, Gilbert, AZ (US); Barry Swen Severson, Gilbert, AZ (US); Calvin Edward Braeutigam, Phoenix, AZ (US)

(21) Appl. No.: 18/741,275

(22) Filed: Jun. 12, 2024

(51) Int. Cl. H04B 1/10; H04B 7/08

(52) U.S. Cl. CPC H04B 1/109; H04B 7/0868

(57) ABSTRACT

Internet is provided using ultra high frequency (UHF). A first direction of a provider device relative to a consumer device is determined. The consumer device is tuned to focus a reception pattern of the consumer device towards the first direction and form one or more nulls in one or more other directions to attenuate one or more other UHF signals received from one or more other sources. A second direction of the consumer device relative to the provider device and a power level of a UHF television signal are determined. The provider device is tuned to focus a radiation pattern of the provider device towards the second direction and control a transmit power of a UHF signal transmitted by the provider device to be at least a predetermined amount less than the power level of the UHF television signal.

### BACKGROUND

The current state of internet connectivity varies widely based on geographical location and/or infrastructure development. For example, high-speed internet is generally more commonly available in urban areas than rural areas due to the concentration of existing infrastructure. However, urban internet connectivity may be susceptible to congestion and/or interference, particularly during peak usage hours, leading to slower speeds, dropped connections, and/or degraded performance. Moreover, the existing infrastructure in at least some urban areas is outdated and/or overstressed, further exacerbating reliability and/or performance issues. Conversely, high-speed internet is generally less commonly available in rural areas due to the lack of existing infrastructure. Building and maintaining conventional wired infrastructure like copper lines and/or fiber-optic cables in rural areas may be impractical or unfeasible due to vast geographical distances and/or challenging terrain. Moreover, at least some known wireless technologies have limitations in terms of speed, reliability, and/or latency.

### SUMMARY

The present disclosure enables internet access to be provided to a variety of locations in an efficient and reliable manner. In one aspect, a method is provided for providing internet using ultra high frequency (UHF). The method includes determining a first direction of a provider device relative to a consumer device, tuning the consumer device to focus a reception pattern of the consumer device towards the first direction and form one or more nulls in one or more other directions to attenuate one or more other UHF signals received from one or more other sources, determining a second direction of the consumer device relative to the provider device and a power level of a UHF television signal, and tuning the provider device to focus a radiation pattern of the provider device towards the second direction and control a transmit power of a UHF signal transmitted by the provider device to be at least a predetermined amount less than the power level of the UHF television signal.

In another aspect, a data augmentation device is provided for providing internet using UHF. The data augmentation device includes a radio and an antenna coupled to the radio. The radio is configured to determine a desired direction and a power level of a UHF television signal, and generate a UHF signal. The antenna is configured to focus a radiation pattern towards the desired direction and transmit the UHF signal at a transmit power at least a predetermined amount less than the power level of the UHF television signal.

In yet another aspect, a system is provided. The system includes a transmitter configured to focus a radiation pattern in a desired direction and transmit a UHF signal at a transmit power at least a predetermined amount less than a power level of a UHF television signal. The system includes a receiver configured to focus a reception pattern towards the transmitter to receive the UHF signal and form one or more nulls in one or more other directions to attenuate one or more other UHF signals received from one or more other sources.

Other aspects and features of the present disclosure will be in part apparent and in part pointed out herein. This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail below with reference to the attached drawing figures, wherein:

FIG. 1 is a block diagram illustrating an example data augmentation device for providing internet using ultra high frequency (UHF);

FIG. 2 is a block diagram illustrating an example node station including a communication device, such as the data augmentation device shown in FIG. 1;

FIG. 3 is a block diagram illustrating an example system for providing internet using a communication device, such as the data augmentation device shown in FIG. 1;

FIG. 4 is a flowchart illustrating an example method for providing internet using a communication device, such as the data augmentation device shown in FIG. 1;

FIG. 5 is a computer architecture diagram illustrating an computing system that may be used to perform one or more computing operations described herein, such as those performed by the data augmentation device shown in FIG. 1;

Corresponding reference numbers indicate corresponding parts throughout the drawings.

### DETAILED DESCRIPTION

According to various examples of the present disclosure, a data augmentation device provides internet connectivity using ultra high frequency (UHF). UHF is a radio frequency in a band on the electromagnetic spectrum between 300 megahertz (MHz) and 3 gigahertz (GHz). The UHF band may be used to support various forms of communication. For example, television broadcasting may utilize radio frequencies within a range between 470 MHz and 890 MHz, although specific frequency ranges may vary depending on the region and regulatory standards. Examples described herein enable internet services to be provided alongside other uses, like television broadcasts, with little or no congestion and/or interference issues. For example, in some examples, a data augmentation device may determine a desired direction and a power level of a UHF television signal, and transmit a UHF signal in the desired direction at a transmit power at least a predetermined amount less than a power level of the UHF television signal. In this manner, the examples described herein may be used to leverage the UHF band to provide efficient use of spectrum bandwidth.

Aspects of the present disclosure provide for a computing system that performs one or more operations in an environment including a plurality of devices coupled to each other via a network (e.g., a local area network (LAN), a wide area network (WAN), the internet). The systems and methods described herein may be implemented using computer programming or engineering techniques including computer software, firmware, hardware, or a combination or subset thereof. Unless defined otherwise, all technical and scientific terms used herein have the same meaning as commonly understood by one of ordinary skill in the art to which the present disclosure belongs. Although any methods and materials similar to or equivalent to those described herein can be used in the practice or testing of the present disclosure, some preferred methods and materials are described below.

The systems and methods disclosed herein provide a technological solution to technical problems by leveraging the UHF band to provide an effective mechanism for providing internet access to a plurality of users. The technical effect of the systems and methods described herein is achieved by using a computing system configured to perform one or more of the following operations: (i) determining a direction of a provider device relative to a consumer device; (ii) tuning the consumer device to focus a reception pattern of the consumer device towards the first direction and form one or more nulls in one or more other directions to attenuate one or more other UHF signals received from one or more other sources; (iii) determining a second direction of the consumer device relative to the provider device and a power level of a UHF television signal; and/or (iv) tuning the provider device to focus a radiation pattern of the provider device towards the second direction and control a transmit power of the first UHF signal to be at least a predetermined amount less than the power level of the UHF television signal.

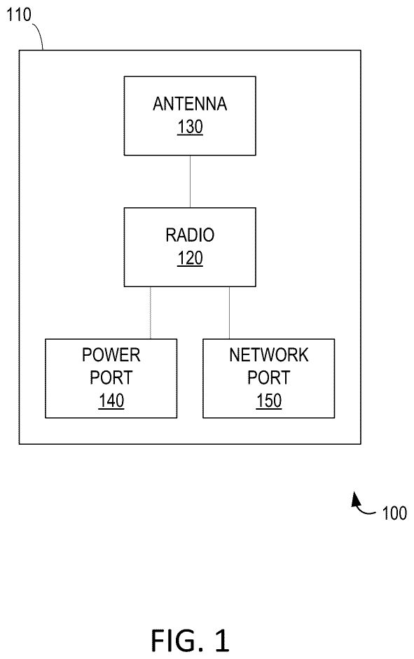

FIG. 1 shows an example data augmentation device 100 for providing internet using ultra high frequency (UHF). In some examples, the data augmentation device 100 may include a housing 110 configured to house and protect various electronic equipment from environmental conditions, such as temperature, humidity, and/or dust. For example, the housing 110 may be used to at least partially house a radio 120 configured to transmit and/or receive radio frequency (RF) signals.

In some examples, the radio 120 may include one or more signal processing systems configured to analyze, synthesize, sample, encode, transform, decode, enhance, transport, archive, and/or otherwise manipulate one or more signals. Transmission-side signal processing systems are generally used to process outgoing signals to enhance their performance for transmission and/or ensure that they meet desired specifications and/or comply with regulatory standards, whereas reception-side signal processing systems are generally used to process incoming signals to enhance their quality, clarity, and/or reliability for further analysis, use, and/or performance. For example, a modulator may be a transmission-side signal processing system used to convert outgoing data into electromagnetic waves for transmission, and a demodulator may be a reception-side signal processing system used to convert incoming electromagnetic waves into usable data for reception. Other signal processing systems may include amplifiers configured to increase a strength or amplitude of a signal, and/or filters configured to selectively allow certain frequencies of ranges of frequencies to pass through while attenuating or blocking others.

The radio 120 may be coupled to one or more antennas 130 that radiates RF signals into surrounding space for transmission and/or captures RF signals from the environment for reception. In some examples, an antenna 130 may be configured to radiate or capture RF signals with special characteristics, such as radiation pattern, polarization, gain, and/or frequency response. For example, the antenna 130 may be used to focus a radiation pattern towards a particular direction based on various factors, such as coverage requirements, distance, user density, and/or environmental conditions. In this manner, the radiation pattern may be adjusted to have one of a plurality of coverage areas, such as a wedge-shaped region over a wide angle (e.g., 60-180 degrees) or a focused beam-shaped region over a narrow angle (e.g., less than 10 degrees).

The data augmentation device 100 may include a power port 140 configured to connect the radio 120 to a power source, such as a power adapter or power supply, in order to provide electrical power for operation and/or charging. In some examples, the power supply may include one or more batteries, generators, solar panels, and/or wind turbines to ensure uninterrupted operation in case of power outages. Additionally, the data augmentation device 100 may include a network port 150 configured to connect the radio 120 to a wired or fiber-optic network for communication and/or data exchange. Example network ports 150 may include, for example, an Ethernet port (e.g., RJ45) or a fiber-optic port (e.g., LC (Lucent Connector), SC (Subscriber Connector), ST (Straight Tip)).

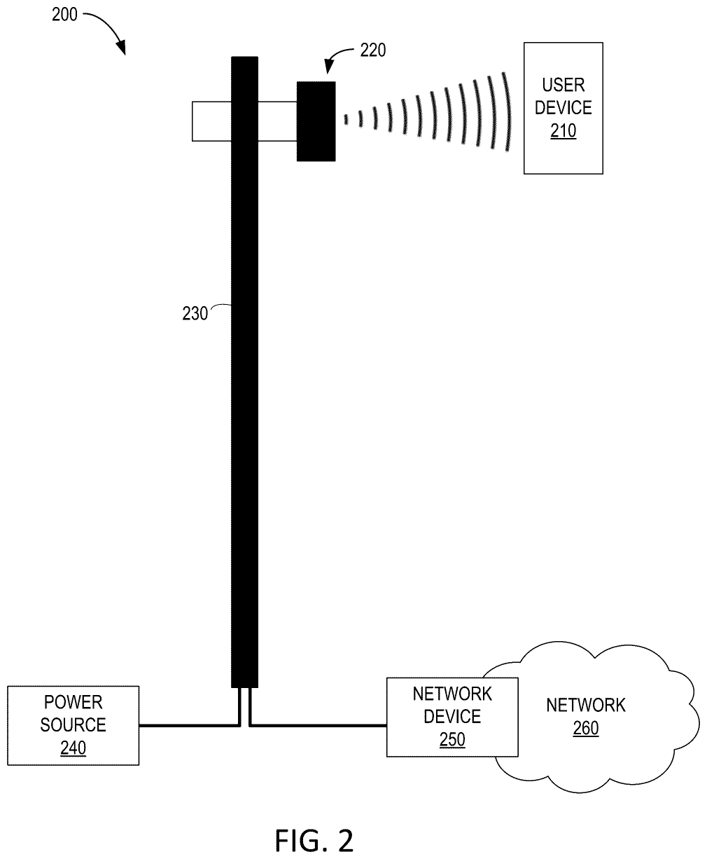

FIG. 2 shows an example node station 200 for providing internet to a user device 210 using a communication device 220 (e.g., data augmentation device 100, radio 120). The node station 200 may be positioned strategically across a region to provide internet connectivity over a coverage area. In some examples, the node station 200 may serve as a point of connection or communication within a radio access network (RAN). For example, the node station 200 may be interconnected with one or more network elements and/or other node stations 200 to facilitate communication between user devices 210 and a core network infrastructure.

The communication device 220 may include and/or be coupled to one or more antennas, transceivers, amplifiers, and/or other equipment to transmit and receive radio signals to and from user devices 210 within the coverage area. For example, the communication device 220 may be used to broadcast a wireless internet connection using UHF such that the user device 210 is able to establish a communication link with the communication device 220. Data, such as web page requests, emails, and/or streaming video, may then be transmitted via UHF between the user device 210 and communication device 220. In some examples, alternative return pathways other than UHF may be utilized.

The coverage area of the wireless internet connection may depend on factors such as the transmit power, the presence of obstacles or interference, and/or the sensitivity of the user device 210. As shown in FIG. 2, the communication device 220 may be mounted to a tower 230 to provide elevation and/or clear line-of-sight with user device 210 and/or another communication device 220, which may help improve signal quality, range, and/or reliability. The tower 230 may be or include any type of structure or support, including a monopole tower, a lattice tower, a guyed tower, and/or a stealth tower.

In some examples, the communication device 220 may be coupled (e.g., via power port 140) to a power source 240 configured to provide power. For example, the communication device 220 may be directly connected to the electrical grid via a direct grid connection. Additionally, the communication device 220 may be connected to a backup power source to ensure continued operation in the event of a power outage. In some examples, the communication device 220 may be coupled (e.g., via network port 150) to one or more network devices 250 connected to a network 260. For example, the communication device 220 may be coupled to the broader internet infrastructure via one or more backhaul connections, which may include fiber-optic cables, coaxial lines, etc. In some examples, a network device 250 may handle communication protocols and/or interface with one or more core network elements to facilitate exchange of data and signaling information between the user device 210, communication device 220, and/or the wider telecommunications network.

In some examples, the communication device 220 and/or network device 250 may include one or more monitoring and/or control systems that allow performance of the node station 200 and/or communication device 220 to be remotely monitored, diagnose issues, and/or perform maintenance tasks. For example, one or more network services may be deployed and/or scaled to facilitate improving resource allocation and/or traffic handling at the node station 200 and/or communication device 220. The monitoring and/or control systems may include one or more sensors, telemetry equipment, and/or network management software to enable one or more management and/or control functionalities to provide provided for monitoring, configuring, and/or maintaining operation of network components, as well as collecting performance data and statistics for network improvement and troubleshooting.

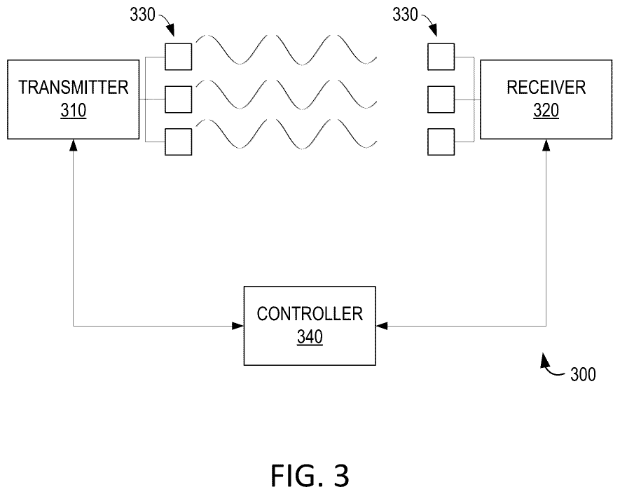

FIG. 3 shows an example system 300 for providing internet using UHF data augmentation to shape and/or control the directionality of transmitted or received UHF signals. UHF data augmentation incorporates a plurality of signal processing systems, processes, and/or techniques for use in increasing signal strength, reducing interference, and/or generally improving a reliability of wireless communication systems. For example, a transmitter 310 (e.g., data augmentation device 100, communication device 220) and a receiver 320 (e.g., user device 210) may both be configured to perform one or more beamforming and/or null-steering operations. Alternatively, the transmitter 310 and/or receiver 320 may be configured to incorporate any signal processing systems, processes, and/or techniques that enables the system 300 to function as described herein.

As shown in FIG. 3, the transmitter 310 and/or receiver 320 may include and/or be coupled to a phased array of antenna elements 330 (e.g., antenna 130) configured to steer or direct UHF signals toward a desired direction. In some examples, the transmitter 310 and/or receiver 320 may include a plurality of phase shifters configured to independently adjust a phase and/or amplitude of a UHF signal transmitted or received by each antenna element 330. For example, the phase shifters may be used to feed an RF current to each of the antenna elements with a phase relationship that enables the UHF signals transmitted from the antenna elements 330 to be constructively combined to form a focused radiation pattern or beam towards a desired direction (e.g., towards the receiver 320). Additionally or alternatively, the phase shifters may be used to adjust the phase and/or amplitude of each of the UHF signals received by the antenna elements 330 and constructively combine them to form a focused reception pattern or beam towards a desired direction (e.g., towards the transmitter 310). Beams may be formed when a plurality of UHF signals meet at a point in space and their amplitudes combine to produce a resultant UHF signal with a greater amplitude than any of the individual UHF signals. When UHF signals are in phase (e.g., their peaks and troughs align), they reinforce each other, resulting in an increase in the overall amplitude of the UHF signal.

In some examples, the phase and/or amplitude of each of the UHF signals may be adjusted to tune a radiation and/or reception pattern of the antenna elements 330 and create or form one or more areas of little or no radiation or “nulls” in one or more directions while maintaining or enhancing signal strength in other directions. Nulls may be formed when a plurality of UHF signals meet at a point in space and their amplitudes combine in such a way that they at least partially cancel each other out. When UHF signals are out of phase (e.g., their peaks and troughs do not align), they interfere in a manner that reduces the overall amplitude of the resultant UHF signal. In this manner, null steering may be used to suppress interference from unwanted sources (e.g., television broadcaster) and/or improve a signal-to-interference ratio at the receiver 320. In some examples, the phase and/or amplitude of a UHF signal may be adjusted mechanically (e.g., by varying a path length using one or more mechanical actuators or switching between transmission lines with different lengths), electrically (e.g., by varying an electrical parameter, such as voltage, current, or capacitance), temporally (e.g., by introducing a controlled delay using a delay line), and/or digitally (e.g., using a series of switches or converters to set discrete phase shift values) to create beams for signals arriving from desired directions while creating nulls for signals arriving from one or more other directions.

To facilitate adjusting the phase and/or amplitude of a UHF signal for beamforming and/or null steering purposes, the transmitter 310 and/or receiver 320 may employ one or more digital signal processing (DSP) techniques to perform one or more signal processing tasks such as modulation, demodulation, filtering, compression, and/or equalization. The DSP techniques may be implemented digitally in software and/or hardware. For example, the transmitter 310 and/or receiver 320 may include a radio frequency analog to digital converter (RFADC) configured to convert analog RF signals into digital signals, a digital to analog converter (RFDAC) configured to convert digital signals into analog RF signals, a central processing unit (CPU) configured to interpret and execute signal processing instructions (e.g., beamforming instructions, null steering instructions), an application specific integrated circuit (ASIC) configured to perform signal processing operations (e.g., beamforming operations, null steering operations), and/or a graphics processing unit (GPU) configured to perform masses of computational tasks in parallel. In some examples, the RFADC, REDAC, CPU, ASIC, and/or GPU may be used to manipulate digital signals using one or more algorithms and/or computational techniques.

In some examples, the transmitter 310 and/or receiver 320 may be coupled to one or more controllers 340 configured to use a beamforming algorithm (e.g., Maximum Ratio Transmission (MRT), Maximum Ratio Combining (MRC), Zero Forcing (ZF), Minimum Mean Square Error (MMSE)) to determine a weight for each UHF signal and/or antenna element 330, and/or control the phase and/or amplitude of UHF signals transmitted or received by each antenna element 330. For example, the controllers 340 may be used to track a target (e.g., receiver 320) and dynamically adjust the phase and/or amplitude of each antenna element 330 in real-time based on feedback (e.g., changes in signal strength, interference, etc.) to steer the beam dynamically towards the desired direction and maintain enhanced performance, efficiency, and/or user experience. In some examples, a controller 340 may be used to prepare or tune the receiver 320 for transmission from the transmitter 310. For example, the antenna elements 330 associated with the receiver 320 may be tuned to facilitate improving or enhancing a UHF signal coming from a direction of the transmitter 310 and/or reducing or attenuating one or more other signals coming in from one or more other directions (e.g., a UHF television signal from a direction of the nearest television broadcaster). In this manner, the receiver 320 may be tuned to distinguish a UHF signal transmitted from the transmitter 310 from one or more other signals, including the UHF television signal. The antenna elements 330 associated with the transmitter 310 may then be used to transmit a UHF signal towards a direction of the receiver 320. In some examples, a power level of the transmission from the transmitter 310 is tuned such that it is predetermined amount less than the power level of the UHF television signal and/or will not interfere with the television broadcast in the coverage area.

While FIG. 3 is described in the context of the transmitter 310 transmitting a UHF signal and the receiver 320 receiving a UHF signal, the transmitter 310 may be configured to employ UHF data augmentation for any received UHF signals and/or the receiver 320 may be configured to employ UHF data augmentation for any transmitted UHF signals. For example, the receiver 320 may be configured to form a focused radiation pattern or beam towards the transmitter 310, and the transmitter 310 may be configured to form a focus reception pattern or beam towards the receiver 320 and form one or more nulls in one or more other directions (e.g., in the direction of the nearest television broadcaster). In this manner, UHF data augmentation may be extended to bidirectional communications where both sides have transmit and receive capabilities.

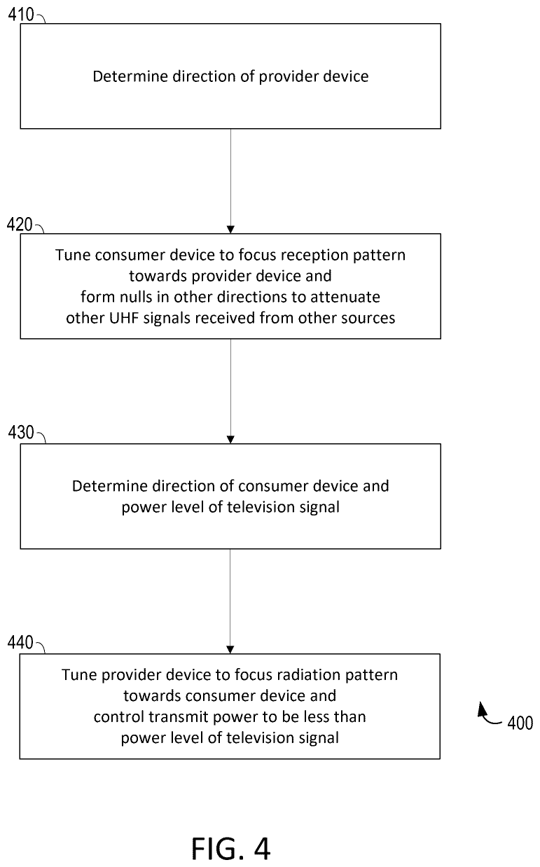

FIG. 4 shows an example method 400 for providing internet using one or more communication devices (e.g., data augmentation device 100, user device 210, communication device 220, transmitter 310, receiver 320). Operation of the communication devices may be managed and/or controlled, for example, using a controller 340 (shown in FIG. 3). A first direction of a source or provider device (e.g., communication device 220, transmitter 310) relative to a target or consumer device (e.g., user device 210, receiver 320) may be determined at operation 410. In some examples, the first direction may be determined based on a known location of the provider device. Alternatively, the first direction may be determined using any system, process, and/or technique that enables the communication devices to function as described herein. For example, the first direction may be determined by detecting, at the consumer device, a first UHF signal from the provider device, measuring a change in a strength or power of the first UHF signal while adjusting a reception pattern of the consumer device, and identifying the reception pattern associated with the strongest first UHF signal.

After the first direction is determined, the consumer device may be tuned at operation 420 to focus the reception pattern towards the first direction (e.g., to form a beam towards the provider device) to facilitate improving or enhancing UHF signals transmitted by the provider device. Additionally, the consumer device may be tuned to create or form one or more nulls in one or more other directions (e.g., towards a television broadcaster) to facilitate reducing or attenuating UHF signals received from one or more other sources (e.g., the television broadcaster). In some examples, the consumer device may be tuned to form the beam towards the provider device and/or form one or more nulls towards the television broadcaster by adjusting a phase and/or amplitude of one or more UHF signals received by the consumer device, varying one or more path lengths, switching between transmission lines with different lengths, varying an electrical parameter (e.g., voltage, current, capacitance), introducing a controlled delay (e.g., using a delay line), and/or using a series of switches or converters to set discrete phase shift values.

A second direction of the consumer device relative to the provider device and a power level of a UHF television signal may be determined at operation 430. The second direction is opposite the first direction. In some examples, the second direction may be determined by detecting, at the provider device, a second UHF signal from the consumer device, measuring a change in a strength or power of the second UHF signal while adjusting a reception pattern of the provider device, and identifying the reception pattern associated with the strongest second UHF signal. The power level of the UHF television signal may be determined relative to the provider device and/or consumer device. In some examples, the power level of the UHF television signal may be determined by detecting the UHF television signal, and measuring a strength or power of the UHF television signal. Alternatively, the power level of the UHF television signal may be determined based on technical specifications published by the television broadcaster (e.g., in regulatory filings, on the television broadcaster's website, etc.) and/or one or more of a location, a height, or a direction of a television broadcast antenna using one or more propagation models.

After the second direction and power level are determined, the provider device may be tuned at operation 440 to focus a radiation pattern towards the second direction (e.g., to form a beam towards the consumer device) to facilitate improving or enhancing UHF signals transmitted to the consumer device. Additionally, the provider device may be tuned to control or adjust a transmit power of the provider device to be at least a predetermined amount less than the power level of the UHF television signal to reduce a likelihood that UHF signals transmitted by the provider device interfere with the UHF television signal while maintaining effective communication with the consumer device. In some examples, the provider device may be tuned to form the beam towards the provider device by adjusting a phase and/or amplitude of one or more UHF signals transmitted by the provider device, varying one or more path lengths, switching between transmission lines with different lengths, varying an electrical parameter (e.g., voltage, current, capacitance), introducing a controlled delay (e.g., using a delay line), and/or using a series of switches or converters to set discrete phase shift values.

In some examples, the consumer device and/or provider device may be further tuned to facilitate bidirectional communication. For example, the consumer device may be tuned to focus a radiation pattern towards the provider device and/or control a transmit power to be at least a predetermined amount less than the power level of the UHF television signal, and/or the provider device may be tuned to focus a reception pattern towards the consumer device. Additionally, the provider device may be tuned to form one or more nulls in one or more other directions (e.g., in the direction of the television broadcast antenna). Alternatively, the consumer device and/or provider device may be tuned in any manner that enables the communication devices to function as described herein.

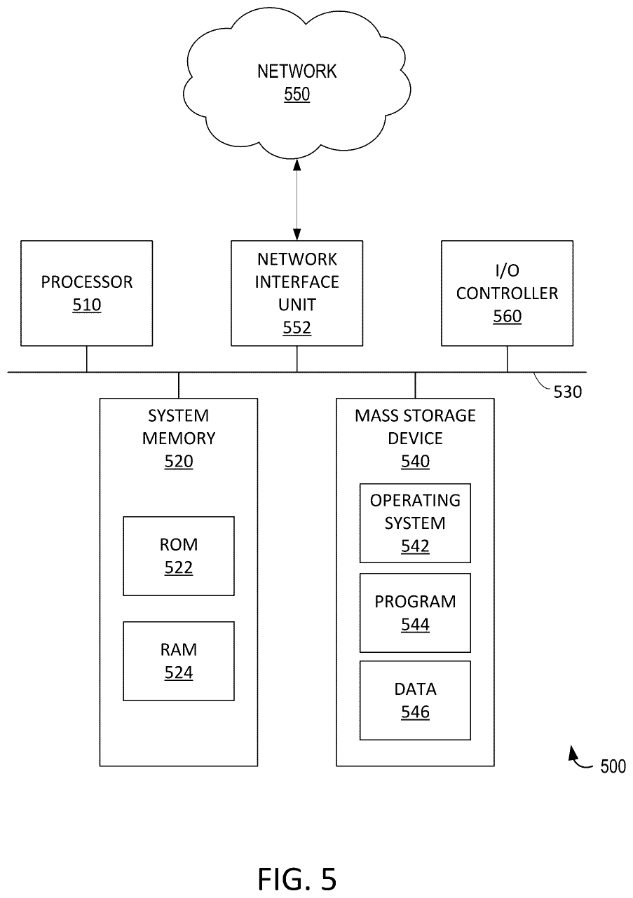

FIG. 5 shows an example computing system 500 (e.g., data augmentation device 100, radio 120, user device 210, communication device 220, network device 250, transmitter 310, receiver 320, controller 340) configured to perform one or more computing operations described herein. In some examples, the computing system 500 includes a processor 510, a system memory 520, and a bus 530 coupling various system components including the system memory 520 to the processor 510.

The processor 510 is configured to perform general computing functions and process data and instructions to perform one or more operations and/or provide other functionality described herein. For example, the processor 510 may access the system memory 520 to read data and instructions from and/or write data and instructions to the system memory 520 for use in executing one or more computer-executable instructions. In this manner, the processor 510 may be programmed to execute any aspect of the software components described herein, including software components for implementing the data augmentation device 100 (shown in FIG. 1), radio 120 (shown in FIG. 1), user device 210 (shown in FIG. 2), communication device 220 (shown in FIG. 2), network device 250 (shown in FIG. 2), transmitter 310 (shown in FIG. 3), receiver 320 (shown in FIG. 3), and/or controller 340 (shown in FIG. 3). In some examples, the processor 510 may be or include any quantity of processing units including a central processing unit, a graphics processing unit, a field-programmable gate array (FPGA), a digital signal processor (DSP), or other hardware logic components including, without limitation, an Application-Specific Integrated Circuit (ASIC), Application-Specific Standard Product (ASSP), System-on-a-Chip System (SOC), Complex Programmable Logic Device (CPLD), etc.

The system memory 520 includes any combination of computer-readable media that may be accessed by the processor 510. In some examples, the system memory 520 includes a read-only memory (ROM) 532 which stores instructions for executing basic functions and a random access memory (RAM) 534 which temporarily stores data and instructions for actively used programs. For example, the RAM 534 may be used to host or store user data, device data, system data, and the like, as well as one or more software components for implementing the data augmentation device 100 (shown in FIG. 1), radio 120 (shown in FIG. 1), user device 210 (shown in FIG. 2), communication device 220 (shown in FIG. 2), network device 250 (shown in FIG. 2), transmitter 310 (shown in FIG. 3), receiver 320 (shown in FIG. 3), and/or controller 340 (shown in FIG. 3).

Computer-readable media includes both communication media and computer storage media. Communication media typically embody computer-readable instructions, data structures, program modules, or other data in a modulated data signal, such as a carrier wave or other transport mechanism. The term “modulated data signal” means a signal that has one or more of its characteristics set or changed in a manner as to encode information in the signal. By way of example, and not limitation, communication media includes wired media, such as a wired network or direct-wired connection, and wireless media, such as acoustic, radio frequency, and infrared media.

In contrast, computer storage media include tangible forms of media that can store information such as computer-readable instructions, data structures, program modules, or other data. By way of example, and not limitation, computer storage media includes ROM 532, RAM 534, hard disk drives (HDDs), solid-state drives (SSDs), external hard drives, flash drives, optical storage media (e.g., compact discs (CDs), digital versatile discs (DVDs), and magnetic storage media (e.g., tape drives). For purposes of the present disclosure, computer storage media is mutually exclusive to communication media and excludes waves, signals, and other transitory or intangible forms of media.

It should be appreciated that the software components described herein, when loaded into the processor 510 and executed, may transform the processor 510 and the overall computing system 500 from a general-purpose computing system into a special-purpose computing system customized to facilitate the functionality described herein. More specifically, the computer-executable instructions contained within the software components described herein transform the processor 510 to operate or function as a finite-state machine by specifying how the processor 510 transitions between states, thereby transforming the transistors or other discrete circuit elements constituting the processor 510.

Encoding the software components described herein may also transform the physical structure of the computer-readable media described herein. The specific transformation of physical structure may depend on various factors, in different implementations of the present disclosure. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the transistors, capacitors, or other discrete circuit elements constituting the semiconductor-based memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In some examples, the computing system 500 includes a mass storage device 540 coupled to the processor 510 for hosting or storing data and instructions, such as an operating system 542, one or more programs 544, and/or data 546. One of ordinary skill in the art would understand that copies of at least some data and/or instructions hosted or stored in the mass storage device 540 may be at least temporarily stored in the system memory 520 to enable the computing system 500 to function as described herein.

As shown in FIG. 5, the computing system 500 may connect to a network 550 (e.g., network 260) through a network interface unit 552 connected to the bus 530. In this manner, the computing system 500 may operate in a networked environment in which the computing system 500 may use one or more remote devices (not shown) to host or store at least some data and/or to execute at least some instructions. Computer communication between computing systems can be a network transfer, a file transfer, an applet transfer, an email, a hypertext transfer protocol (HTTP) transfer, and so on.

In some examples, the computing system 500 may include one or more input/output (I/O) controllers 560 that facilitate communication and data transfer between the processor 510 and one or more I/O devices (not shown) configured to provide input and/or output capabilities. For example, a user may enter commands and information into the computing system 500 using one or more input devices, such as a keyboard, pointing device (e.g., mouse, trackball, touch pad, stylus), microphone, camera, scanner, accelerometer, and the like. Additionally or alternatively, the computing system 500 may present various forms of information, such as text, images, audio, video, alerts, and the like, using one or more output devices, such as a monitor, projector, printer, speaker, actuator, and the like. In some examples, the output device may be integrated with the input device (e.g., in a touchscreen panel or in a controller including a vibrating component).

While some examples are illustrated and described herein with reference to the computing system 500 being, including, or being included in the data augmentation device 100 (shown in FIG. 1), radio 120 (shown in FIG. 1), user device 210 (shown in FIG. 2), communication device 220 (shown in FIG. 2), network device 250 (shown in FIG. 2), transmitter 310 (shown in FIG. 3), receiver 320 (shown in FIG. 3), and/or controller 340 (shown in FIG. 3), aspects of the present disclosure are operable with any computing system that can execute computer-executable instructions to implement the operations and functionality associated with the computing system 500. It is also contemplated that the computing system 500 may not include all of the components shown in FIG. 5, may include other components that are not explicitly shown in FIG. 5, or may utilize an architecture completely different than that shown in FIG. 5. The computing system 500 should not be interpreted as having any dependency or requirement relating to any one or combination of components shown in FIG. 5. The computing system 500 is only one example of a computing and networking environment for performing one or more computing operations and is not intended to suggest any limitation as to the scope of use or functionality of the present disclosure.

Example methods and systems are described herein for processing UHF signals to enable internet data to be shared on the UHF spectrum while providing little or no interference to existing UHF television broadcasters and/or users. Accordingly, examples described herein may be used to provide internet connectivity to a variety of populations, including those in remote locations and/or those in locations with inadequate infrastructure, without installing additional underground wiring and/or infrastructure. In view of the above, it will be seen that several advantages of the aspects of the present disclosure are achieved and other advantageous results attained.

Although described in connection with an example computing system environment, examples of the present disclosure are capable of implementation with numerous other general purpose or special purpose computing system environments, configurations, or devices. Examples of well-known computing systems, environments, and/or configurations that may be suitable for use with aspects of the disclosure include, but are not limited to, server computers, desktop computers, laptop computers, tablets, mobile devices, communication devices in wearable or accessory form factors, microprocessor-based systems, multiprocessor systems, programmable consumer electronics, kiosks, tabletop devices, industrial control devices, minicomputers, mainframe computers, network computers, distributed computing environments that include any of the above systems or devices, and the like.

Examples of the present disclosure may be described in the general context of computer-executable instructions, such as program modules, executed by one or more computers or other devices in software, firmware, hardware, or a combination thereof. The computer-executable instructions may be organized into one or more computer-executable modules or components. Generally, program modules include, but are not limited to, routines, objects, components, and data structures that perform particular tasks or implement particular abstract data types. Aspects of the disclosure may be implemented with any number and organization of such modules or components. For example, aspects of the present disclosure are not limited to the specific computer-executable instructions or the specific components or modules illustrated in the figures and described herein. Other examples of the present disclosure may include different computer-executable instructions or components having more or less functionality than illustrated and described herein.

In some examples, the operations illustrated in the drawings may be implemented as software instructions encoded on a computer readable medium, in hardware programmed or designed to perform the operations, or both. For example, aspects of the present disclosure may be implemented as a system on a chip or other circuitry including a plurality of interconnected, electrically conductive elements.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

The order of execution or performance of the operations in examples of the present disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the present disclosure.

The examples illustrated and described herein as well as examples not specifically described herein but within the scope of aspects of the present disclosure constitute example means for providing internet using UHF. For example, the elements illustrated in FIGS. 1-3 and, when programmed, encoded, or configured to perform the operations illustrated in FIG. 4, constitute at least an example means for determining a direction of a provider device relative to a consumer device (e.g., radio 120, user device 210, network device 250, receiver 320, controller 340), tuning the consumer device to focus a reception pattern of the consumer device towards the first direction (e.g., radio 120, user device 210, network device 250, receiver 320, controller 340), determining a second direction of the consumer device relative to the provider device and a power level of a UHF television signal (e.g., radio 120, user device 210, communication device 220, network device 250, transmitter 310, receiver 320, controller 340), and/or tuning the provider device to focus a radiation pattern of the provider device towards the second direction and control a transmit power of the first UHF signal to be at least a predetermined amount less than the power level of the UHF television signal (e.g., radio 120, communication device 220, network device 250, transmitter 310, controller 340).

When introducing elements of aspects of the disclosure or the examples thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

In the present description, reference numbers have sometimes been used in connection with various terms. Where a term is used in connection with a reference number, this may be meant to refer to a specific element that is shown in one or more of the figures. Where a term is used without a reference number, this may be meant to refer generally to the term without limitation to any particular figure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the aspects of the present disclosure have been described in terms of various examples with their associated operations, a person skilled in the art would appreciate that a combination of operations from any number of different examples is also within the scope of the aspects of the present disclosure.

What is claimed is:

1. A method for providing internet using ultra high frequency (UHF), the method comprising:
determining a first direction of a provider device relative to a consumer device, the provider device configured to transmit a first UHF signal;
tuning the consumer device to focus a reception pattern of the consumer device towards the first direction and form one or more nulls in one or more other directions to attenuate one or more other UHF signals received from one or more other sources;
determining a second direction of the consumer device relative to the provider device and a power level of a UHF television signal; and
tuning the provider device to focus a radiation pattern of the provider device towards the second direction and control a transmit power of the first UHF signal to be at least a predetermined amount less than the power level of the UHF television signal.

2. The method of claim 1, wherein determining the first direction comprises:
detecting at the consumer device one or more test UHF signals transmitted by the provider device; and
measuring a change in a strength of the one or more test UHF signals while adjusting the reception pattern of the consumer device.

3. The method of claim 1, wherein tuning the consumer device comprises adjusting one or more of a phase or an amplitude of the first UHF signal received at the consumer device.

4. The method of claim 1, wherein determining the second direction comprises:
detecting at the provider device one or more test UHF signals transmitted by the consumer device; and
measuring a change in a strength of the one or more test UHF signals while adjusting a reception pattern of the provider device.

5. The method of claim 1, wherein determining the power level comprises:
detecting the UHF television signal; and
measuring a strength of the UHF television signal.

6. The method of claim 1, wherein tuning the provider device comprises adjusting one or more of a phase or an amplitude of a second UHF signal transmitted by the provider device.

7. The method of claim 1, further comprising:
tuning the consumer device to focus a radiation pattern of the consumer device towards the first direction and control a transmit power of the consumer device to be at least the predetermined amount less than the power level of the UHF television signal; and
tuning the provider device to focus a reception pattern of the provider device towards the second direction and form one or more nulls in one or more other directions to attenuate one or more other UHF signals received from one or more other sources.

8. A data augmentation device for providing internet using ultra high frequency (UHF), the data augmentation device comprising:
a radio configured to determine a desired direction and a power level of a UHF television signal, and generate a first UHF signal; and
an antenna coupled to the radio, the antenna configured to focus a radiation pattern towards the desired direction and transmit the first UHF signal at a transmit power at least a predetermined amount less than the power level of the UHF television signal.

9. The data augmentation device of claim 8, wherein the antenna is configured to receive one or more test UHF signals transmitted by a user device, and the radio is configured to adjust a reception pattern and measure a change in a strength of the one or more test UHF signals while adjusting the reception pattern.

10. The data augmentation device of claim 8, wherein the antenna is configured to receive one or more test UHF signals transmitted by a user device, and the radio is configured to form one or more nulls based on the one or more test UHF signals to attenuate one or more other UHF signals received from one or more other sources.

11. The data augmentation device of claim 8, wherein the antenna is configured to receive the UHF television signal, and the radio is configured to measure a strength of the UHF television signal.

12. The data augmentation device of claim 8, wherein the antenna is configured to receive the UHF television signal, and the radio is configured to form one or more nulls based on the UHF television signal to attenuate the UHF television signal.

13. The data augmentation device of claim 8, wherein the radio is configured to adjust one or more of a phase or an amplitude of the first UHF signal.

14. The data augmentation device of claim 8, wherein one or more of the radio or the antenna is configured to focus a reception pattern towards the desired direction.

15. The data augmentation device of claim 8, further comprising a power port coupleable to a power supply.

16. The data augmentation device of claim 8, further comprising a network port coupleable to a communication network.

17. A system comprising:
a transmitter configured to focus a first radiation pattern in a desired direction and transmit a first UHF signal at a first transmit power at least a predetermined amount less than a power level of a UHF television signal; and
a receiver configured to focus a first reception pattern towards the transmitter to receive the first UHF signal and form one or more nulls in one or more other directions to attenuate one or more other UHF signals received from one or more other sources.

18. The system of claim 17, further comprising a controller configured to adjust one or more of a phase or an amplitude of the first UHF signal transmitted by the transmitter.

19. The system of claim 17, further comprising a controller configured to adjust one or more of a phase or an amplitude of the first UHF signal received at the receiver.

20. The system of claim 17, wherein the transmitter is configured to focus a second reception pattern towards the receiver and form one or more nulls in one or more other directions to attenuate one or more other UHF signals received from one or more other sources, and the receiver is configured to focus a second radiation pattern towards the transmitter and transmit a second UHF signal at a second transmit power at least the predetermined amount less than the power level of the UHF television signal.
